(19) United States
(12) Patent Application Publication
(10) Pub. No.: US 2014/0254965 A1
(43) Pub. Date: Sep. 11, 2014

(54) LINKAGE APPARATUS HAVING A LOW PROFILE ASYMMETRICAL HEAD

(71) Applicant: Roller Bearing Company of America, Inc., Oxford, CT (US)

(72) Inventors: Stephanie Giegel, Streetsboro, OH (US); Brian Gaumer, Trabuco Canyon, CA (US); Scott McNeil, Gilford, NH (US)

(73) Assignee: ROLLER BEARING COMPANY OF AMERICA, INC., Oxford, CT (US)

(21) Appl. No.: 14/199,983

(22) Filed: Mar. 6, 2014

Related U.S. Application Data
(60) Provisional application No. 61/773,273, filed on Mar. 6, 2013.
(60) Provisional application No. 61/773,511, filed on Mar. 6, 2013.

(51) Int. Cl. F16C 33/20; F16C 17/02

(52) U.S. Cl. CPC F16C 33/201; F16C 17/02
USPC 384/276; 384/129

(57) ABSTRACT

A high-cycle, short range-of-motion linkage apparatus is provided for actuating a positioning device. The linkage apparatus includes a pivot member having a head portion configured to receive by plastic deformation a bearing assembly therein. The head portion defines a bore therein having a substantially cylindrical inner surface that defines an inner diameter having a first center point. The head portion further defines a truncated arcuate outer surface, a portion of which defines a radius of curvature and a second center point. A stem having a central axis extends from the pivot member along the central axis in a first direction. The second center point is offset from the first center point in the first direction and a distance between the first center point and the second center point, measured along the central axis, is in the range of up to about 33% of the radius of curvature.

### CROSS REFERENCE TO RELATED APPLICATIONS

This application claims the benefit of U.S. Provisional Patent Application No. 61/773,273 filed on Mar. 6, 2013, and U.S. Provisional Patent Application No. 61/773,511 filed on Mar. 6, 2013, the contents of both of which are incorporated herein by reference in their entirety.

### TECHNICAL FIELD

The present invention is directed to a linkage apparatus having a low profile asymmetrical head, more particularly, to a linkage apparatus having a low profile asymmetrical head with a swaged self-lubricating bearing disposed in the head, the linkage apparatus for use in short shanked clevis joints and in high-cycle, short range-of-motion linkages for gas turbine engines.

### BACKGROUND

Linkages are used in many applications to move or actuate components in a predetermined manner. In the aircraft industry, linkages are used to move or actuate various components of gas turbine engines. For example, a linkage can be pivotally coupled to a structural member of a turbofan engine fan bleed system. In addition, linkages can be used in variable bypass vane (“VBV”) actuator assemblies for the control of bleed and/or bypass air in a VBV actuator system for a turbofan engine.

Typically, the linkages include a bearing, such as a spherical bearing disposed in a head portion of the linkage. The head portion is configured to pivotally engage a receiving member, such as a clevis. In some instances, the clevis has short shanked flanges or uprights which limit the size of the head of the linkage that can be received in the clevis. If the flanges or uprights of a clevis extending outward from a base are too short, a shaft engaged in the bearing will not properly engage a bore defined in the clevis flanges. Often, a linkage apparatus will be modified by machining or milling a flat in an arcuate outer surface of the head. Such a configuration reduces the thickness of the head so that the modified head properly engages the clevis. However, this configuration requires an additional fabrication process, creates local stress concentrations and reduces the load carrying capability of the linkage.

### SUMMARY

In one aspect, the present invention resides in a linkage apparatus for actuation of a positioning device. The linkage apparatus comprises a pivot member having a head portion configured to receive by plastic deformation a bearing assembly therein. The head portion defines a bore therein having a substantially cylindrical inner surface that defines an inner diameter having a first center point. The head portion further defines a truncated arcuate outer surface, a portion of which defines a radius of curvature and a second center point. A stem having a central axis extends from the pivot member along the central axis in a first direction. The second center point is offset from the first center point in the first direction and a distance between the first center point and the second center point, measured along the central axis, is in the range of up to about 33% of the radius of curvature.

In another aspect, the present invention resides in a linkage apparatus for actuation of a positioning device. The linkage apparatus comprises a positioning member defining a first end, a second end, and a central axis therethrough. A pivot member is defined at the first end of the positioning member and has a head portion configured to receive by plastic deformation a bearing assembly therein. The head portion defines a bore therein having a substantially cylindrical inner surface that defines an inner diameter having a first center point. The head portion further defines a truncated arcuate outer surface, a portion of which defines a radius of curvature and a second center point. A stem extends from the pivot member along the central axis of the positioning member in a first direction. A coupling member is defined at the second end of the positioning member for coupling the positioning member to a structural member. The second center point is offset from the first center point in the first direction and a distance between the first center point and the second center point, measured along the central axis, is in the range of up to about 33% of the radius of curvature.

### BRIEF DESCRIPTION OF THE DRAWINGS

FIG. 1A is a side cross-sectional view of one embodiment of a bearing of the present invention.

FIG. 1B is a side cross-sectional view of another embodiment of a bearing of the present invention.

FIG. 1C provides a depiction of an oscillatory rotational range-of-motion of the bearing of FIG. 1A or FIG. 1B.

FIG. 1D provides a depiction of misalignment of the bearing of FIG. 1A or FIG. 1B.

FIG. 2 is a side cross-sectional view of a linkage apparatus of the present invention into which the bearing of FIG. 1A or FIG. 1B is mounted.

FIG. 3A is an exploded perspective view of one embodiment of mounting the linkage apparatus of FIG. 2 to a structural member.

FIG. 3B is an exploded perspective view of another embodiment of mounting the linkage apparatus of FIG. 2 to a structural member.

FIGS. 3C, 3D and 3E are exploded sectional views of the linkage apparatus of FIG. 3B.

FIG. 4 is a side cross-sectional view of one embodiment of the linkage apparatus of FIG. 2 into which the bearing of FIG. 1A or FIG. 1B is mounted into a first end and a second end of the linkage apparatus.

FIG. 5 is a side cross-sectional view of another embodiment of the linkage apparatus of FIG. 2 comprising an actuator.

FIG. 6 is a perspective view of one embodiment of a positioning member of the present invention, namely, a turbofan engine variable bypass vane actuator assembly, which is engaged by the linkage apparatus of FIG. 2.

FIG. 7A is a side view of another embodiment of the linkage apparatus of FIG. 2.

FIG. 7B is another side view of a portion of the linkage apparatus of FIG. 7A showing portions of an arcuate outer surface of a head portion of the linkage apparatus.

FIG. 7C is a cross sectional view of a portion of the linkage apparatus of FIG. 7B taken across line C-C.

FIG. 8 is an isometric view of a section of the linkage apparatus of FIG. 7A taken along line A-A of FIG. 7A and provides the results of a stress analysis of the linkage apparatus.

FIG. 9 is an isometric view of a portion of the section of the linkage apparatus of FIG. 8 and provides additional results of the stress analysis of the linkage apparatus.

FIG. 10 is another isometric view of the portion of the section of the linkage apparatus of FIG. 8 and provides a plot of the stresses exhibited at certain locations of the linkage apparatus.

FIG. 11A is a front view of one embodiment of the linkage apparatus of FIG. 2 having a load slot bearing assembly mounted therein.

FIGS. 11B and 11C are isometric views of the linkage apparatus of FIG. 11A.

### DETAILED DESCRIPTION

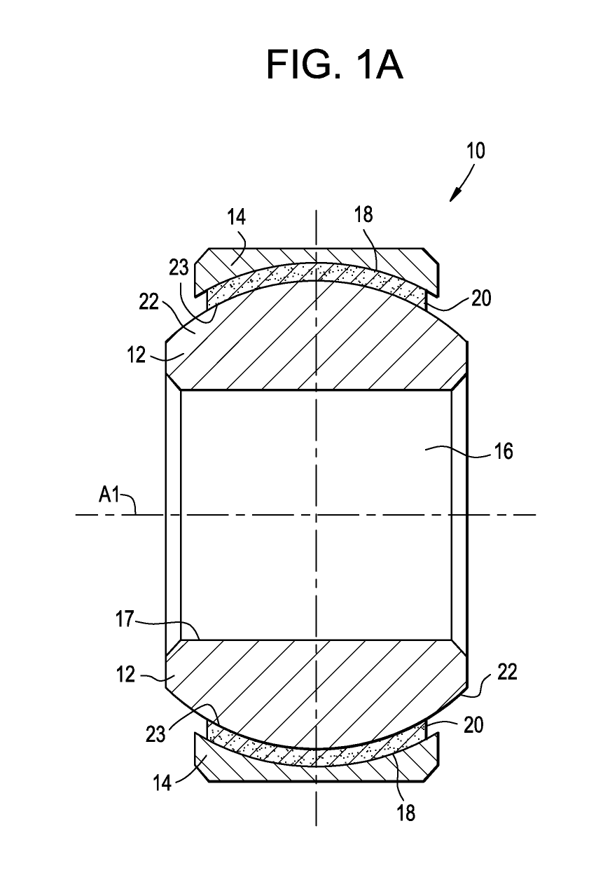

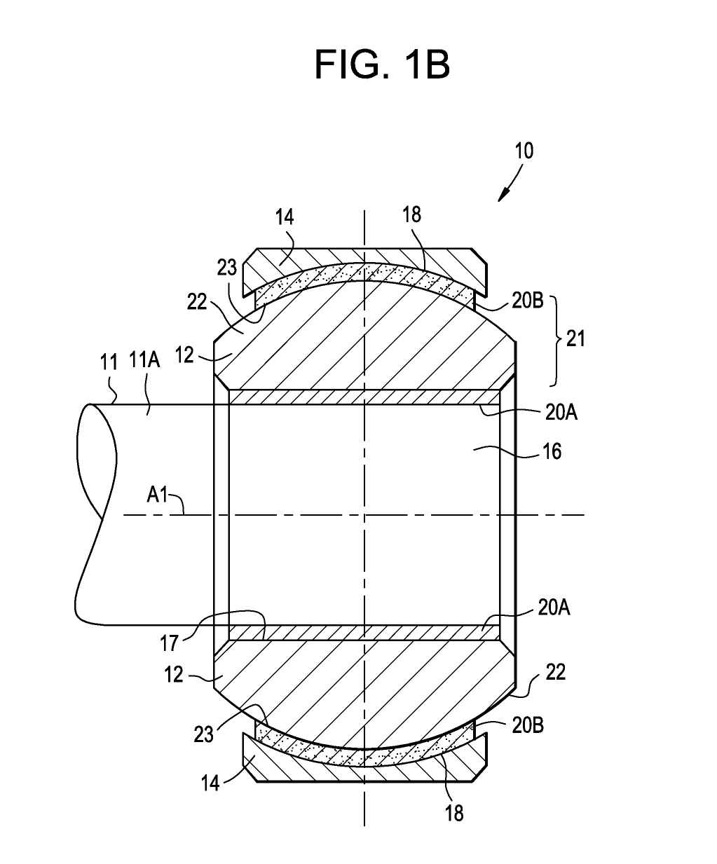

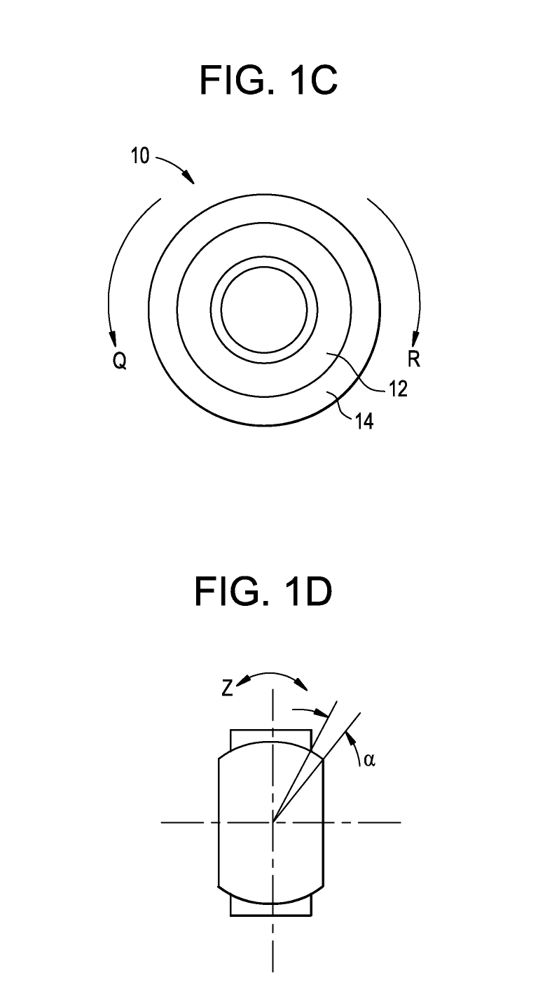

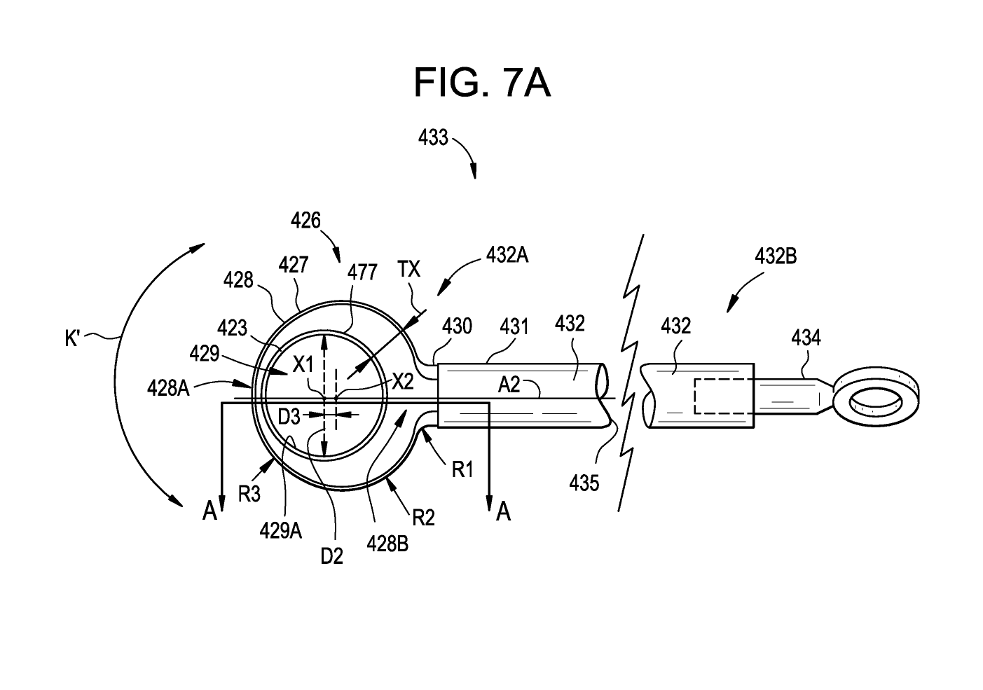

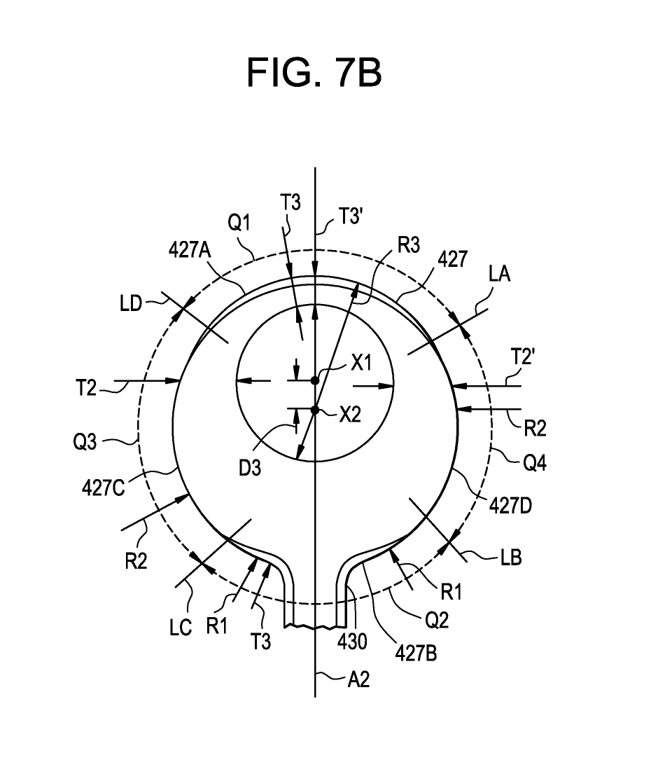

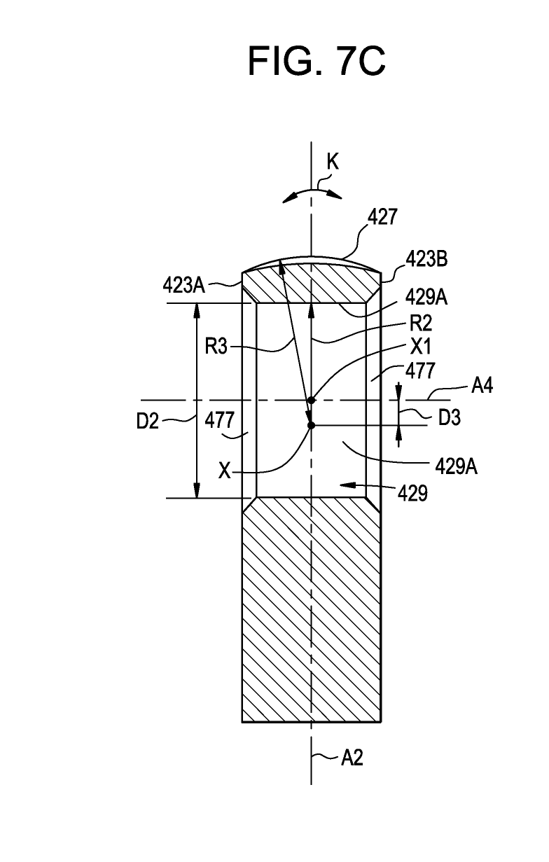

As shown in FIGS. 1-10, one embodiment of a linkage apparatus is provided for actuation of a positioning device of a turbofan engine fan bleed air system, and in particular for actuation of a variable bypass vane actuator assembly. The linkage apparatus supports a static radial load of up to about 20,000 lbs and preferably is fabricated from a martensitic precipitation/age-hardening stainless steel alloy. As described herein with reference to FIGS. 7A-7C, a linkage apparatus 433 includes a positioning member 432 having a low profile head portion 428 configured to receive a bearing assembly therein, a stem 430, and a coupling member 434 defined for coupling the positioning member 432 to a structural member.

As shown in FIGS. 1A and 1B, a spherical plain bearing assembly is designated generally by the reference number 10 and is hereinafter referred to as “bearing assembly 10.” The bearing assembly 10 includes an inner member or a ball 12 positioned in an outer member or an outer race 14. A central axis “A1” is defined through the bearing assembly 10. The ball 12 defines an outer surface 22, a portion of which is an outer engagement surface 23. The ball 12 further defines a bore 16 extending therethrough and adapted to receive a portion of a shaft or other component therein. The bore 16 defines an inner surface 17 of the ball 12. The present invention is not so limited, as the ball 12 may be integral with or form part of a shaft or other component, or the ball 12 may define a split-ball configuration. In addition, the outer race 14 may define a load slot or may be integral with or form part of a housing or other component. Moreover, while the bore 16 is shown and described as extending through the ball 12, the present invention is not limited in this regard as the bore can extend partway through the ball, the bore may define a stepped-bore, or the ball may not define a bore, without departing from the broader aspects of the invention.

In the illustrated embodiment, the outer race 14 is a ring having an inner surface, a portion of which is an inner engagement surface 18 on which a self-lubricating liner 20 is disposed. The liner 20 slidingly engages the outer engagement surface 23 of the ball 12. The inner engagement surface 18 is contoured to a shape complementary to the outer engagement surface 23 of the ball 12. As shown, at least a portion of the inner engagement surface 18 is concave, and at least a portion of the outer surface 23 of the ball 12 is convex. When the ball 12 is located in the outer race 14, the outer surface 22 slidingly engages the liner 20. While the outer race 14 has been shown and described as being a ring, the present invention is not limited in this regard as the outer race can assume any practical shape or be integrally formed as part of another component, such as, for example, a housing, without departing from the broader aspects of the invention. Although the liner 20 is shown and described as being disposed on the inner engagement surface 18 of the outer race 14, the present invention is not limited in this regard as the liner 20 may be disposed on the outer engagement surface 23 of the ball 12 and slidingly engage the inner engagement surface 18 of the outer race 14.

As shown in FIG. 1B, one embodiment of the bearing assembly 10 includes a dual liner system 21. A first or primary liner 20A is disposed on the inner surface 17 of the ball 12. A second or secondary liner 20B is disposed on the inner engagement surface 18 of the outer race 14. The primary liner 20A engages an outer surface 11A of a shaft 11 that extends at least partially into the bore 16 of the ball 12. When the shaft 11 is located in the ball 12, the outer surface 11A slidingly engages the liner 20A. When the ball 12 is located in the outer race 14, the outer surface 22 slidingly engages the liner 20B. Accordingly, a primary low-friction interface is provided by the primary liner 20A to accommodate rotation of the shaft 11 with respect to the bearing assembly 10, and in particular, the outer race 14. As a backup or redundant provision, a secondary low-friction interface is provided by the secondary liner 20B to accommodate rotation of the shaft 11 with respect to the bearing assembly 10, and in particular, the outer race 14. Accordingly, should the primary low-friction interface provided by the primary liner 20A seize, the secondary low-friction interface provided by the secondary liner 20B will bear the moment loading movement.

While the primary liner 20A is shown and described as being disposed on the inner surface 17 of the ball 12, the present invention is not limited in this regard as the primary liner 20A may be disposed on the outer surface 11A of the shaft 11 and slidingly engage the inner surface 17 of the ball 12. While the secondary liner 20B is shown and described as being disposed on the inner engagement surface 18 of the outer race 14, the present invention is not limited in this regard as the secondary liner 20B may be disposed on the outer engagement surface 23 of the ball 12 and slidingly engage the inner engagement surface 18 of the outer race 14. While the primary liner 20A is shown and described as being disposed on the inner surface 17 of the ball 12 while the secondary liner is shown and described as being disposed on the inner engagement surface 18 of the outer race 14, the present invention is not limited in this regard as the primary liner 20A may be disposed on one of the inner surface 17 of the ball 12 or the outer surface 11A of the shaft 11, and no liner may be disposed between the outer race 14 and the ball 12.

The ball 12 is made from any suitable material, such as metal or alloys. Suitable metals and alloys from which the ball 12 may be fabricated include, but are not limited to, stainless steels (e.g., 440C, A286, and the like), nickel-chromium-based superalloys (e.g., Inconel and the like), titanium, titanium alloys, silicon nitride, silicon carbide, zirconium, and the like.

The outer race 14 is made from any suitable material, such as metal or alloys. Suitable metals from which the outer race 14 may be fabricated include, but are not limited to, stainless steels (e.g., 17-4 PH® stainless steel), titanium, titanium alloys, and the like. The present invention is not so limited, however, as ceramics may be used in the construction of the outer race 14.

In one embodiment, the self-lubricating liner 20, 20A, 20B comprises a high-temperature self-lubricating liner system. One embodiment of the self-lubricating liner 20, 20A, 20B comprises a polytetrafluoroethylene (“PTFE”). One embodiment of the self-lubricating liner 20, 20A, 20B comprises PTFE bonded or impregnated with a thermoset resin. Another embodiment of the self-lubricating liner 20, 20A, 20B comprises perfluorooctanoic acid (“PFOA”) PTFE, such as Teflon®, bonded with a polyimide resin system. The present invention is not limited to the use of a polyimide resin, however, as other thermoset resins including, but not limited to, phenolic and amino resins and polyamides, are within the scope of the present invention. One embodiment of the self-lubricating liner 20, 20A, 20B comprises a PFOA-Free Teflon® liner. For example, the self-lubricating liner 20, 20A, 20B is a Teflon® liner containing no PFOA or substantially no PFOA. Another embodiment of the self-lubricating liner 20, 20A, 20B comprises a Teflon® liner containing PFOA. One embodiment of the self-lubricating liner 20, 20A, 20B comprises PTFE and a phenolic resin reinforced with fibers. For example, one embodiment of the self-lubricating liner 20, 20A, 20B comprises PTFE and a layer of low-friction material, namely, a phenolic resin reinforced with aramid fibers, such as, for example, Nomex®. The fiber may comprise a plain, twill or satin weave. The present invention is not limited to the use of aramid fibers, however, as other fibers including, but not limited to, glass, polyester, glass woven with Teflon®, and carbon fibers are within the scope of the present invention. The use of PTFE and a thermoset resin reinforced provides for toughness, high wear resistance, and protection against dynamic, high frequency vibratory loads. (Nomex® and Teflon® are registered trademarks of E. I. du Pont de Nemours and Company, Wilmington, Del.).

In one embodiment, the self-lubricating liner 20, 20A, 20B comprises a solid film lubricant such as molybdenum disulfide, graphite, or tungsten disulfide. In another embodiment, the self-lubricating liner 20, 20A, 20B comprises a metallic or semi-metallic coating or plating with antigalling or anti-fretting properties, such as, for example, silver plating, electroless nickel-Teflon® plating, or thermal spray coatings including high velocity oxygen fuel (“HVOF”) sprayed coatings or plasma sprayed coatings.

The liner 20, 20A, 20B is suited for use in moderate to high temperature environments and is particularly suited for use in turbofan engines. The thermoset resin used to formulate the liner 20, 20A, 20B selectively is phenolic for moderate temperature applications in the range of about 300° F. to about 500° F., and polyimide for higher temperature applications in the range of about 500° F. to about 600° F. For lower temperature applications up to about 350° F., the liner 20, 20A, 20B may be fabricated as a homogenous machinable liner formulated from a curable acrylate composition with various fillers for structure and PTFE for lubrication. The liner 20, however, is not limited to PTFE and a thermoset resin as other material(s) are suitable for use in the moderate to high temperature environments in which the bearing assembly 10 is to be used. Other liners that may be used include, but are not limited to, those with different fabric reinforcements, machinable materials (for example, materials without fabric reinforcement but with other reinforcement structures), and other self-lubricating materials that may include polyimide resins. Additionally, the liner 20, 20B could be attached to supporting structure without the outer race 14.

During operation of the bearing assembly 10, the liner 20, 20B on the inner engagement surface 18 of the outer race 14 engages the outer engagement surface 23 of the ball 12, thereby causing the ball 12 to move slidably and rotatably relative to the outer race 14; and/or the liner 20A on the inner surface 17 of the ball 12 engages the outer surface 11A of the shaft 11, thereby causing the shaft 11 to move slidably and rotatably relative to the ball 12. The liner 20, 20A, 20B is particularly suited for high-cycle engagement within a short range-of-motion. A high-cycle oscillatory rotational range-of-motion of the outer race 14 in relation to the ball 12, as shown by the directional arrows Q and R in FIG. 1C, can range from 0° up to 90°, 270° and 360°. In particular, such high-cycle angular range-of-motion can range from about 15° to about 45°. More particularly, such high-cycle angular range-of-motion can range from about 5° to about 10°. Accordingly, the bearing assembly 10 is particularly suited for high-cycle engagement within a short range-of-motion for moderate temperature applications in the range of about 300° F. to about 500° F., and for higher temperature applications in the range of about 500° F. to about 600° F. In addition, when the ball 12 is partially or fully disposed in the outer race 14, the ball 12 is misalignable and rotatable in relation to the outer member 14 as shown by the directional arrow Z and up to the angle α shown in FIG. 1D.

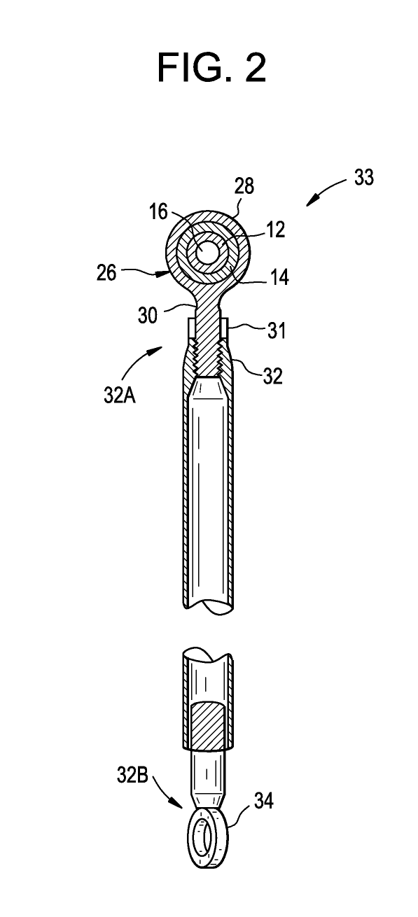

As shown in FIG. 2, a linkage apparatus is generally designated by the reference number 33. Suitable uses of the linkage apparatus 33 include, but are not limited to, use in aircraft, aerospace, heavy equipment, vehicular applications and applications involving high-cycle short range of motion. The linkage apparatus 33 includes a positioning member 32 that is generally tubular. A socket 26 is positioned on a first end 32A of the positioning member 32, and a coupling member 34 is positioned on a second end 32B thereof, as described herein. A bearing 10 is positioned in the socket 26 by, for example, staking in accordance with National Aerospace Standard 0331 (NAS 0331) “Bearing Installation and Retention by Swaging or Staking”. The bearing 10 includes the liner 20 disposed on the inner engagement surface 18 of the outer race 14 (FIG. 1A), or the dual liner system 21 (FIG. 1B). The socket 26 has a head portion 28 and a neck or stem 30 extending therefrom that is removably secured or threadedly received in a receiving portion 31 of the positioning member 32 The socket 26 is moveable between at least a first position and a second position, for example, by threading the stem 30 into the receiving portion 31. While the stem 30 is described as being removably secured or threadedly received in a receiving portion 31, the present invention is not limited in this regard as the stem may be integral with or press fit into the receiving portion 31. The coupling member 34 is employed for coupling the positioning member 32 to a structural member 29 or the like as further described herein. In one embodiment, the coupling member 34 is press fit into a second end 32B of the positioning member 32. Although the coupling member 34 has been described as being press fit into the second end 32B of the positioning member 32, other methods for securing the coupling member 34 within the second end 32B of the positioning member 32, such as, for example, by threaded engagement, pins and corresponding apertures and other like fastening means, or by cooling the coupling member 34 and heating the coupling member 34, are considered within the scope of the invention.

The linkage apparatus 33 is especially suitable for use in pneumatic actuators, variable geometry systems, and as support links for accessories. In addition, the linkage apparatus 33 is particularly suitable as a high-cycle, short range-of-motion linkage apparatus for actuation of one or more positioning devices. Such positioning devices particularly include turbofan engine component linkages, such as, for example, a variable bypass vane actuator assembly.

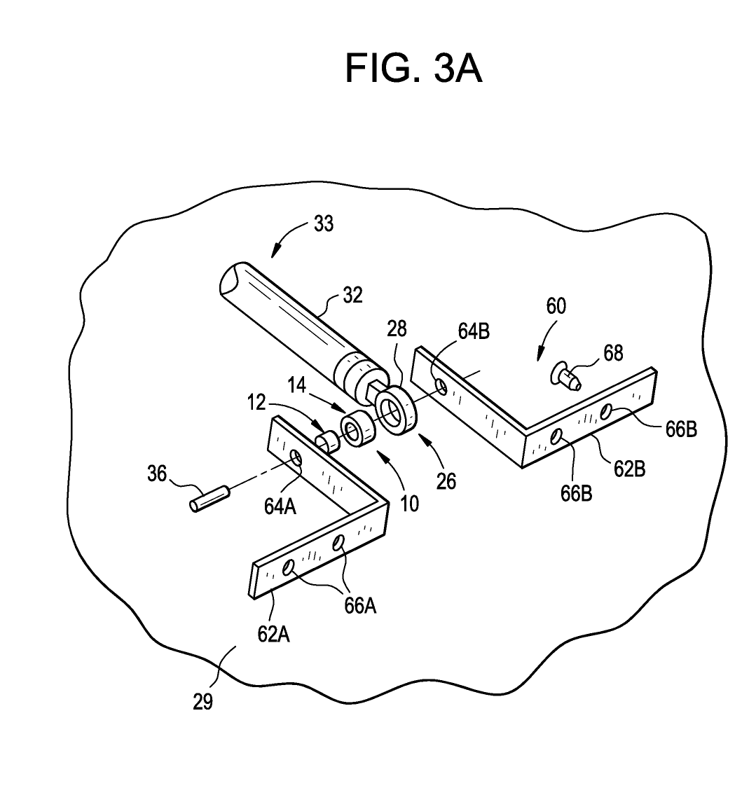

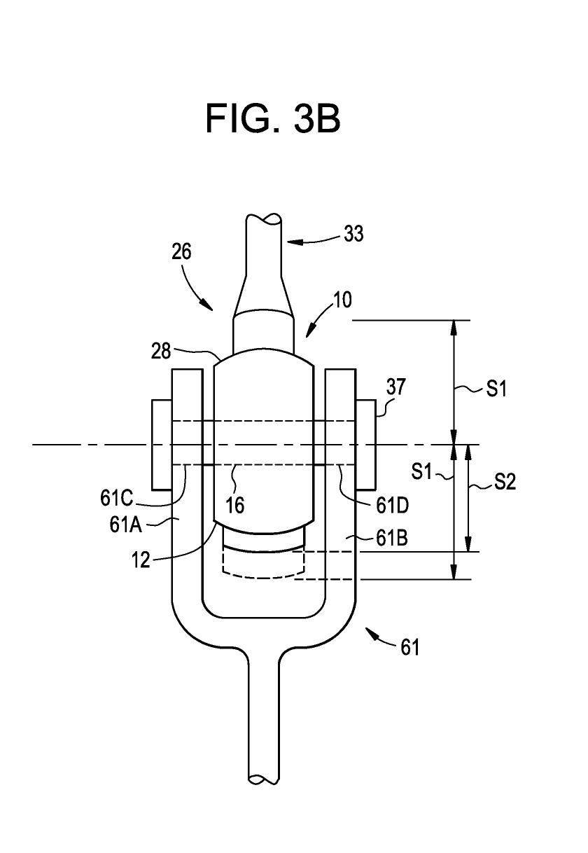

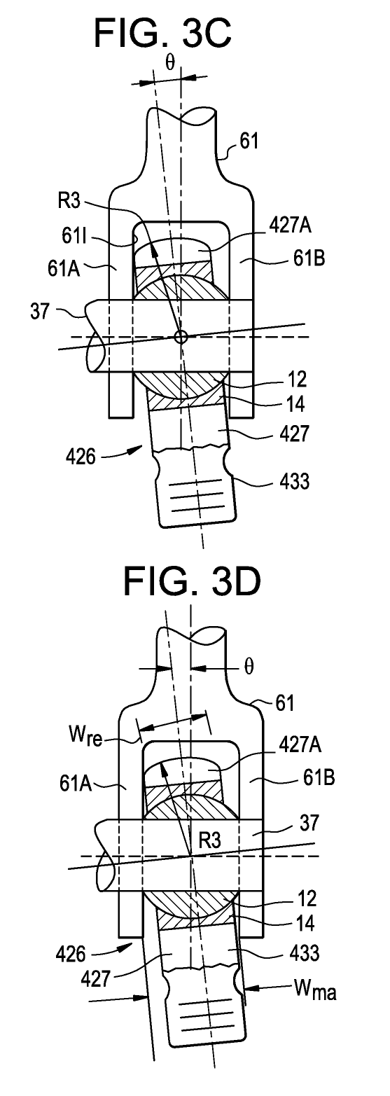

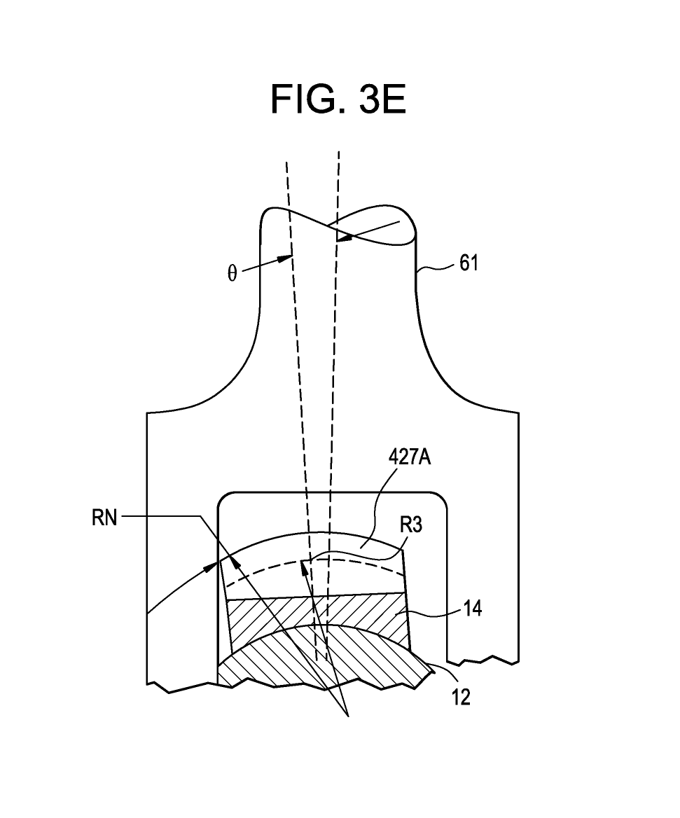

As shown in FIG. 3A, one embodiment of mounting the linkage apparatus 33 to the structural member 29 includes coupling the linkage apparatus 33 to a mounting assembly 60 that is, in turn, removeably and securely fastened to the structural member 29. In one embodiment, the structural member 29 is a structural member of a turbofan engine fan bleed system or air bypass system. The bearing assembly 10 is staked into the head portion 28 of the socket 26, for example in accordance with NAS 0331. The bearing 10 includes the liner 20 disposed on the inner engagement surface 18 of the outer race 14 (FIG. 1A), or the dual liner system 21 (FIG. 1B). The bearing assembly 10 is pivotally connected to a pair of mounting brackets 62A and 62B via a shaft or pin 36 extending through the bearing assembly 10. The pin 36 is secured in the bore 16 of the bearing assembly 10 and in a pair of apertures 64A and 64B defined respectively in the mounting brackets 62A and 62B via a press fit. The press fit, also known as an interference fit or friction fit, is maintained by friction after the pin 36 has been pushed or driven into the bore 16 and the apertures 64A and 64B by a process such as staking, for example in accordance with NAS 0331.

In one embodiment, the pin 36 is slightly undersized, thereby creating an initial slip fit within the bore 16 and the apertures 64A and 64B. A staking punch is then used to compress the pin 36 radially and thereby form the press fit or interference fit between the pin 36 and the bore 16 and the apertures 64A and 64B. The press fit relies upon the tensile and compressive strengths of the materials from which the respective parts are fabricated. Although the pin 36 has been described as being press fit or staked into the bore 16 and the apertures 64A and 64B, other methods for engaging the pin 36 within the bore 16 and the apertures 64A and 64B, for example, by cooling the pin 36 and heating the bore 16 and the apertures 64A and 64B, are considered within the scope of the invention. In addition, the pin 36 may be integrally formed with the ball 12.

Each of the mounting brackets 62A and 62B are removeably and securely fastened to the structural member 29 by fasteners 68 (only one fastener 68 shown) threadedly received within correspondingly tapped apertures (not shown) in the structural member 29. The present invention is not limited in this regard as the fasteners 68 may comprise a pin that is press fit into corresponding apertures in the structural member 29, the press fit being as described hereinabove with respect to the pin 36, the bore 16 and the apertures 64A and 64B. While fasteners 68 are shown and described for removeably and securely fastening the mounting brackets 62A and 62B to the structural member 29, the present invention is not limited in this regard as the mounting brackets 62A and 62B may be fixedly connected to the structural member 29 by any number of material joining means, such as, for example, use of suitable adhesives, welding, or being integrally forged or cast therewith, may also be employed without departing from the broader aspects of the invention.

As shown in FIG. 3B, one embodiment of mounting the linkage apparatus 33 to a structural member includes coupling the linkage apparatus 33 to a mounting assembly 61 that is, in turn, removeably and securely fastened to the structural member. Mounting assembly 61 comprises a clevis configuration for retaining therein the bearing assembly 10 of the linkage apparatus 33. The bearing assembly 10 is staked into the head portion 28 of the socket 26, for example in accordance with NAS 0331. In one embodiment and as shown in FIG. 3B, the ball 12 is staked into the head portion 28 of the socket 26; the bearing assembly 10 not having an outer race 14. The bearing 10 includes the liner 20 disposed on the inner engagement surface 18 of the outer race 14 (FIG. 1A), or the dual liner system 21 (FIG. 1B). The bearing assembly 10 is pivotally connected to the mounting assembly 61 via a shaft or pin 37 extending through the ball 12 of the bearing assembly 10 and respective apertures 61C and 61D of arms 61A and 61B of the clevis configuration of the mounting assembly 61. In the embodiment of the bearing assembly 10 comprising the dual liner system 21 (FIG. 1B), the pin 37 slidingly engages the bore 16 of the ball 12 of the bearing assembly 10. The linkage apparatus 33 defines a first shank distance S1 and a second shank distance or a short shank distance S2 which is less than S1.

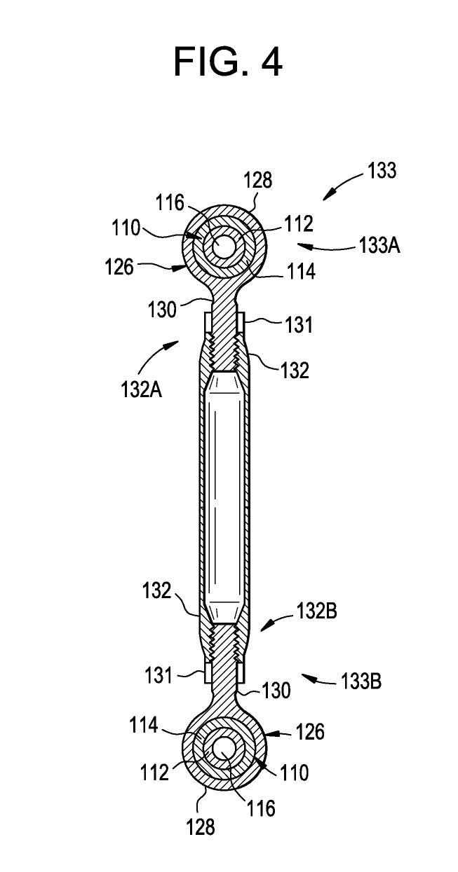

A linkage apparatus 133 is depicted in FIG. 4 and is similar to the linkage apparatus 33 shown in FIG. 2, thus like elements are given a like element number preceded by the numeral 1.

As shown in FIG. 4, the linkage apparatus 133 comprises a positioning member 132 that defines a first end 132A and a second end 132B. Each of the first and second ends 132A and 132B of the positioning member 132 include a pivot member or socket 126 having a head portion 128 and a stem 130 extending therefrom. The stem portion 130 is removably secured, for example, threadedly received in a receiving portion 131 of the positioning member 132. Each of the sockets 126 have a bearing assembly 110 staked therein, for example in accordance with NAS 0331. Each of the bearing assemblies 110 includes a ball 112 defining a bore 116 therethrough, an outer race 114 and a liner 20 (FIG. 1A) disposed between the ball 112 and the outer race 114, or a dual liner system 21 (FIG. 1B). Thus, the linkage apparatus 133 comprises bearing assemblies 110 staked into sockets 126 at a first end 133A and a second end 133B of the linkage apparatus 133.

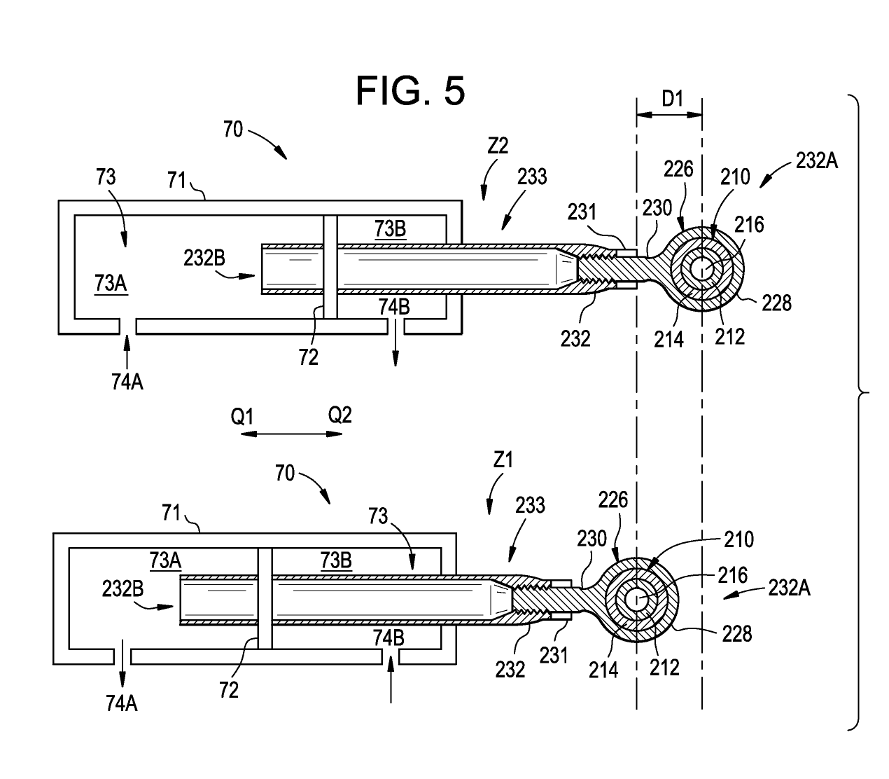

A linkage apparatus 233 for actuation of a positioning device is depicted in FIG. 5 and is similar to the linkage apparatus 33 shown in FIG. 2, thus like elements are given a like element number preceded by the numeral 2.

The linkage apparatus 233 depicted in FIG. 5 comprises an actuator such as, for example, a pneumatic actuator 70, that is shown in a retracted position R1 and an extended position R2. The actuator 70 that includes an actuator housing 71 and the linkage apparatus 233 comprises a positioning member 232 that defines a first end 232A and a second end 232B. The first end 232A of the positioning member 232 has a pivot member or socket 226 having a head portion 228 and a stem 230 extending therefrom that is removably secured or threadedly received in a receiving portion 231 of the positioning member 232. The socket 226 has a bearing assembly 210 staked therein, for example in accordance with NAS 0331. The bearing assembly 210 includes a ball 212 defining a bore 216 therethrough, an outer race 214 and a liner 20 (FIG. 1A) disposed between the ball 212 and the outer race 214, or a dual liner system 21 (FIG. 1B). While actuator 70 is shown and described as a pneumatic actuator, the present invention is not limited in this regard as a hydraulic actuator, an electro-mechanical actuator and the like may also be employed without departing from the broader aspects of the invention. In one embodiment, the actuator 70 comprises a hydraulic actuator using engine fuel as a hydraulic fluid therein.

The second end 232B of the linkage apparatus 233 is fixedly secured to a moveable block, plunger or piston 72 of the actuator 70 for actuation of the positioning device (not shown). The piston 72 divides an interior volume 73 of the actuator housing 71 into a first interior volume 73A and a second interior volume 73B. The interior volume 73 of the actuator housing 71 is in communication with a motive fluid such as a hydraulic fluid or pressurized air, as described further herein.

The actuation of the positioning device is initiated when the piston 72 and the linkage apparatus 233 is in the retracted position R1. In operation, the hydraulic fluid is pumped into the first interior volume 73A via a port 74A formed in the housing 71, at a pressure P1, and a corresponding amount of hydraulic fluid is released from the second interior volume 73B via a port 74B formed in the housing 71, at a pressure P2 which is less than pressure P1. The influx of the hydraulic fluid into the first interior volume 73A (and the corresponding release of hydraulic fluid from the second interior volume 73B) causes the piston 72 to advance in a direction indicated by the arrow Q2, thereby extending the linkage apparatus 233 in the direction Q2 such that the bearing assembly 210 advances a distance D1 in the direction Q2, thereby extending or actuating a positioning device. Similarly, the hydraulic fluid is pumped into the second interior volume 73B via the port 74BA, at a pressure P1, and a corresponding amount of hydraulic fluid is released from the first interior volume 73A via the port 74A, at a pressure P2 which is less than pressure P1. The influx of the hydraulic fluid into the second interior volume 73B (and the corresponding release of hydraulic fluid from the first interior volume 73A) causes the piston 72 to retract in a direction indicated by the arrow Q1, thereby retracting the linkage apparatus 233 in the direction Q1 such that the bearing assembly 210 retracts the distance D1 in the direction Q1, thereby retracting or de-actuating the positioning device. The force that acts upon the positioning device is equal to the pressure P1 of the hydraulic fluid pumped into the interior volume 73 of the housing 71 multiplied by the area of the piston 72. Accordingly, linkage apparatus 233 comprises the actuator 70 having a positioning member 232 that defines a shaft or socket 26 extending therefrom and is operable between the retracted condition or position Z1 and the extended condition or position Z2 to move the positioning 232 member between at least the position Z1 and the position Z2.

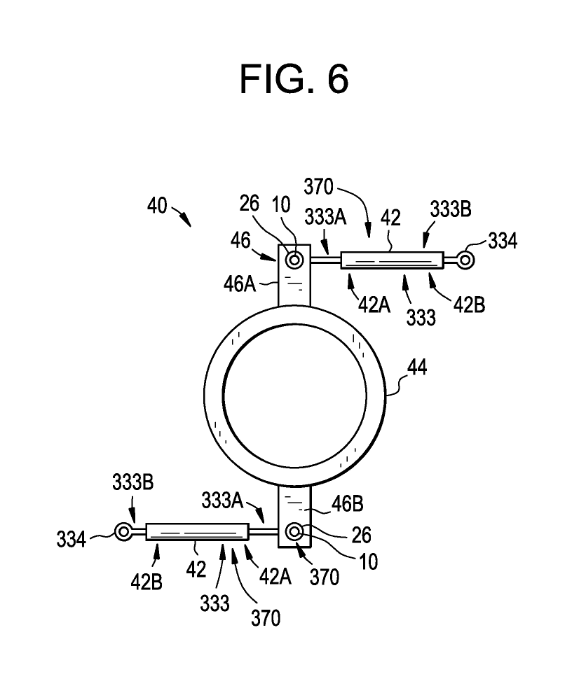

A linkage apparatus 333 for actuation of a positioning device is depicted in FIG. 6 and is similar to the linkage apparatus 33 shown in FIG. 2, thus like elements are given a like element number preceded by the numeral 3.

As shown in FIG. 6, one embodiment of the linkage apparatus 333 is configured for use in a variable bypass vane (“VBV”) actuator assembly for the control of bleed and/or bypass air in a VBV actuator system for a turbofan engine. In the VBV actuator system, a set of stator vanes internal to the turbofan engine is adjusted to obtain a smoother air flow through the turbofan engine. The VBV actuator system is shown generally at 40 and is hereinafter referred to as “system 40.” System 40 comprises an actuator ring 44 defining one or more flanges 46, for example, two flanges 46A and 46B are shown. The linkage apparatus 333 includes an actuator 370 (similar to the actuator 70 shown in FIG. 5) pivotally secured to each of the flanges 46 proximate a first end 333A of the linkage apparatus 333. In particular, the pivotal connection between the actuator 370 and the flange 46 is provided via the bearing assembly 10, mounting brackets 62A and 62B, and shaft or pin 36 similar to that depicted in FIG. 3A. The linkage apparatus 333 further comprises a positioning member 42 having a first end 42A and a second end 42B. The actuator 370 is received within or fixedly attached to the first end 42A of the positioning member 42. The actuator 370 includes a socket 26 (as shown in FIG. 3A) comprising a bearing assembly 10 as described above with reference to FIG. 1A or FIG. 1B. In one embodiment, a coupling member 334 is received within or fixedly attached to the second end 42B of the positioning member 42 for coupling the positioning member 42 to a structural member (not shown). The present invention is not so limited as the linkage apparatus 333 may define the linkage apparatus 133 depicted in FIG. 4 such that a second actuator (not shown) is received within or fixedly attached to the second end 42B of the positioning member 42. Upon operation of the actuator 370, the flange 46 and/or the actuator ring 44 is moved to adjust the stator vanes (not shown) in the turbofan engine. The bearing assemblies 310 in the sockets 326 allow for the desired operation of the system 40 at the temperatures encountered in the turbofan engine. While the linkage apparatus 333 comprising the pneumatically operable actuator 370 having a socket 326 and a bearing assembly 310 is shown and described as being operable with VBV actuator assembly, system 40, the present invention is not limited in this regard as the linkage apparatus 333 is configured to be operable with other embodiments of a VBV actuator assembly without departing from the broader aspects of the invention.

A linkage apparatus 433 for actuation of a positioning device is depicted in FIG. 7A and is similar to the linkage apparatus 33 shown in FIG. 2, thus like elements are given a like element number preceded by the numeral 4.

As shown in FIG. 7A, the linkage apparatus 433 comprises a positioning member 432 that defines a first end 432A, a second end 432B, and a central axis “A2” therethrough. The first end 432A of the positioning member 432 comprises a pivot member or socket 426 having a head portion 428 configured to receive a bearing assembly 10 therein similar to the bearing 10 of FIG. 1A or FIG. 1B. The bearing assembly 10 comprises a ball 12, an outer race 14 and a liner 20 disposed between the ball 12 and the outer race 14 (FIG. 1A), or the dual liner system 21 (FIG. 1B). The socket 426 defines a shank or stem 430 extending therefrom that is removably secured or threadedly received in a receiving portion 431 of the positioning member 432. The head portion 428 defines a distal end or a first end 428A and a mating end or a second end 428B proximate the receiving portion 431 of the positioning member 432.

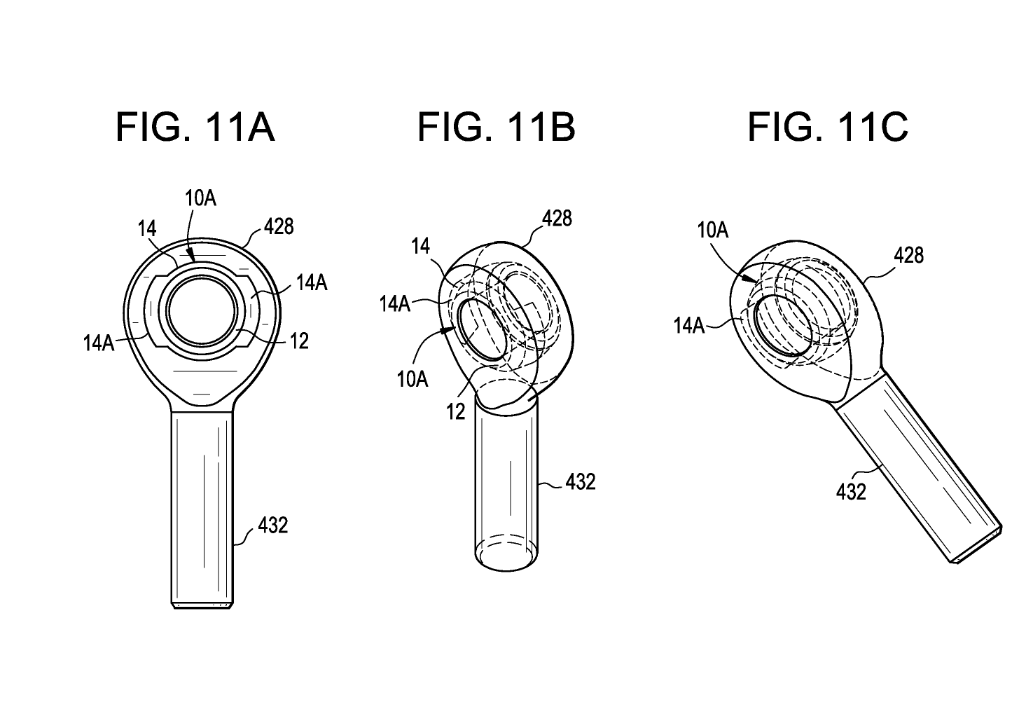

In one embodiment, the head portion 428 is configured to receive a spherical plain bearing assembly staked or coined therein by plastic deformation. In one embodiment, the spherical plain bearing assembly comprises an angular contact self-aligning bearing. In another embodiment and as shown in FIGS. 11A-11C, the head portion 428 is configured to receive a load slot bearing 10A wherein the outer race 14 defines one or more slots 14A to permit insertion of the ball 12 therein, such as, for example, by swaging, for example in accordance with NAS 0331. In yet another embodiment, the head portion 428 is configured to receive a bearing wherein the outer race defines a split-race cartridge. In yet another embodiment, the head portion 428 is integrally formed with the outer race of a bearing assembly. In other embodiments, the ball may comprise a split-ball or a spring-ball or the like which is received in the outer race of the bearing assembly.

In one embodiment of the linkage apparatus 433, the second end 432B of the positioning member 432 defines a coupling member 434 for coupling the positioning member 432 to a structural member (not shown) as described above with reference to FIG. 2. In one embodiment, the coupling member 434 is configured to couple the positioning member 432 to a structural member of a turbofan engine fan bleed air system. More particularly, the linkage apparatus 433 is configured to be operable with a VBV actuator assembly. In another embodiment, the second end 432B of the positioning member 432 comprises a truncated end of the positioning member 432 defining an end face 435 configured to be fixedly attached to a structural member (not shown) by, for example, welding, or fixedly received within a structural member by, for example, a press fit.

Still referring to FIGS. 7A and 7C, the head portion 428 of socket 426 defines a truncated arcuate outer surface 427 extending laterally in the direction of the arrow K between a first end face 423A and a second end face 423B (shown only in FIG. 7C). The first end face 423A and the second end face 423B are substantially parallel to each other, as shown in FIG. 7C. The arcuate surface 427 also extends circumferentially in the direction of the arrow K′ around the head portion 428, as shown in FIG. 7A. In one embodiment, the arcuate outer surface 427 approximates a substantially spherical outer surface. As best shown in FIG. 7C, a chamfer 477 extends inwardly from each of the first end face 423A and the second end face 423B. The head portion 428 of socket 426 further defines a bore 429 extending therethrough. The bore 429 defines a substantially cylindrical inner surface 429A that has an inner diameter “D2.” In one embodiment, the cylindrical inner surface 429A of the bore 429 is substantially perpendicular to the first end face 423A and second end face 423B of the arcuate outer surface 427 of the head portion 428 of socket 426. In one embodiment, D2 is in the range of about 0.875 inch to about 1.125 inches, and more particularly about 1.0 inch. In one embodiment, the cylindrical inner surface 429A of the bore 429, and thus the inner diameter D2, define a central axis A4 (see FIG. 7C) that intersects with the central axis A2 of the linkage apparatus 433, thereby defining a first center point “X1” of the bore 429. In the embodiment illustrated in FIGS. 7A-C, the inner surface 429A and the arcuate outer surface 427 are not concentric such that the center point X1 is offset from the center point X2. In one embodiment, the arcuate outer surface 427 is defined by a substantially constant radius of curvature. In one embodiment, the inner surface 429A and the arcuate outer surface 427 are concentric.

As shown in FIG. 7B, the arcuate outer surface 427 is defined, in part, by a plurality of radii of curvature such that the arcuate outer surface 427 has: 1) a first spherical outer surface section 427A which extends across an arc Q1 which extends between a first plane LA and a fourth plane LD; 2) a second spherical outer surface section 427B which extends across an arc Q2 which extends between a second plane LB and a third plane LC; 3) a third spherical outer surface section 427C which extends across an arc Q3 which extends between the third plane LC and the fourth plane LD; and 4) a fourth spherical outer surface section 427D which extends across an arc Q4 which extends between the first plane LA and the second plane LB. The first and second spherical outer surface sections 427A and 427B are blended therebetween by the third spherical outer surface section 427C on one side (i.e., at the third plane LC and the fourth plane LD). The first and second spherical outer surface sections 427A and 427B are blended therebetween by the fourth spherical outer surface section 427D on an opposing side (i.e., at the first plane LAC and the second plane LB). Accordingly, each spherical outer surface section 427A, 427B, 427C, 427D defines a different radius of curvature than the spherical outer surface sections 427A, 427B, 427C, and/or 427D that are adjacent thereto. For example and as shown in FIGS. 7A and 7B, in one embodiment, the arcuate outer surface 427 is defined by a plurality of transitioning radii of curvature R1, R2, and R3 wherein R1<R2<R3. In particular, the first spherical outer surface section 427A defines radius of curvature R3; the second spherical outer surface section 427B defines radius of curvature R1; and the third and fourth spherical outer surface sections 427C and 427D each define radius of curvature R2. A material thickness “T1” extends from the cylindrical inner surface 429A of the bore 429 to the arcuate outer surface 427. In such an embodiment, T1 ranges from a maximum thickness along the spherical outer surface section 427B having radius R1 (proximate the second end 428B of the head portion 428), through an intermediate thickness along the arcuate outer surface sections 427C and 427D having radius R2, and transitioning to a lesser thickness along the spherical outer surface section 427A having radius R3 (proximate the first end 428A of the head portion 428). The minimum thickness T1 occurs at the first end 428A of the head portion 428 along the axis A2. In one embodiment: (i) R1 ranges from about 0.125 inch to about 0.375 inch, and more particularly is about 0.175 inch; (ii) R2 ranges from about 0.750 inch to about 0.875 inch, and more particularly is about 0.817 inch; and (iii) R3 ranges from about 0.875 inch to about 1.0 inch, and more particularly is about 0.950 inch. At least one of the outer surface sections, for example spherical outer surface section 427A having radius R3, defines a spherical center point or a second center point “X2” along the central axis A2 of the linkage apparatus 433. In one embodiment, the first center point X1 of the bore 429 is offset from the second center point X2 of the spherical outer surface section 427A by an offset distance “D3.” Such an embodiment of the linkage apparatus 433, having the offset distance D3 is referred to herein as a “low profile linkage apparatus.” In one embodiment of the low profile linkage apparatus, the offset distance D3 is in the range of up to about 33% of the radius of curvature R3 of the spherical outer surface section 427A, and more particularly in the range of about 5% to about 25% of the radius of curvature R3. In one embodiment, the offset distance D3 is in the range of about 10% to about 15% of the radius of curvature R3.

Referring back to FIGS. 3C, 3D and 3E, the linkage apparatus 433 is misalignable in relation to the mounting assembly 61 wherein the mounting assembly 61 comprises the head portion 428 of the socket 426 having the truncated arcuate outer surface 427 as shown in FIG. 7B. The spherical outer surface section 427A defines the radius R3 and the thickness T3. The rod end or the head 428 defines a width Wre. The linkage apparatus 33 defines a width Wma. Such width is also defined by a distance between mounting brackets to which the linkage apparatus 33 is secured, for example the mounting brackets 62A and 62B of FIG. 3A. As indicated, a maximum misalignment of the linkage apparatus 33 in relation to the mounting assembly 61 occurs when the spherical outer surface section 427A impinges on an inwardly facing surface 61E of the arm 61A of the mounting assembly 61 and defines a maximum misalignment angle θ. As shown in FIG. 3E, a greater maximum misalignment of the linkage apparatus 33 in relation to the mounting assembly 61 is provided by the outer surface section 427A defining the radius R3 in relation to a socket head having a uniform thickness and defining a radius RN. The reduction in the radius from radius RN to radius R3 provides for greater maximum misalignment of the linkage apparatus 33 in relation to the mounting assembly 61. The maximum misalignment angle θ is determined in accordance with the following mathematical expression:

0=sin⁻¹(T3/R3×2)−sin⁻¹(Wre/R3×2)

where: θ=the maximum misalignment angle; T3=the thickness of the outer surface section 427A; R3=the radius of the outer surface section 427A; and Wre=width of the rod end or the head 428.

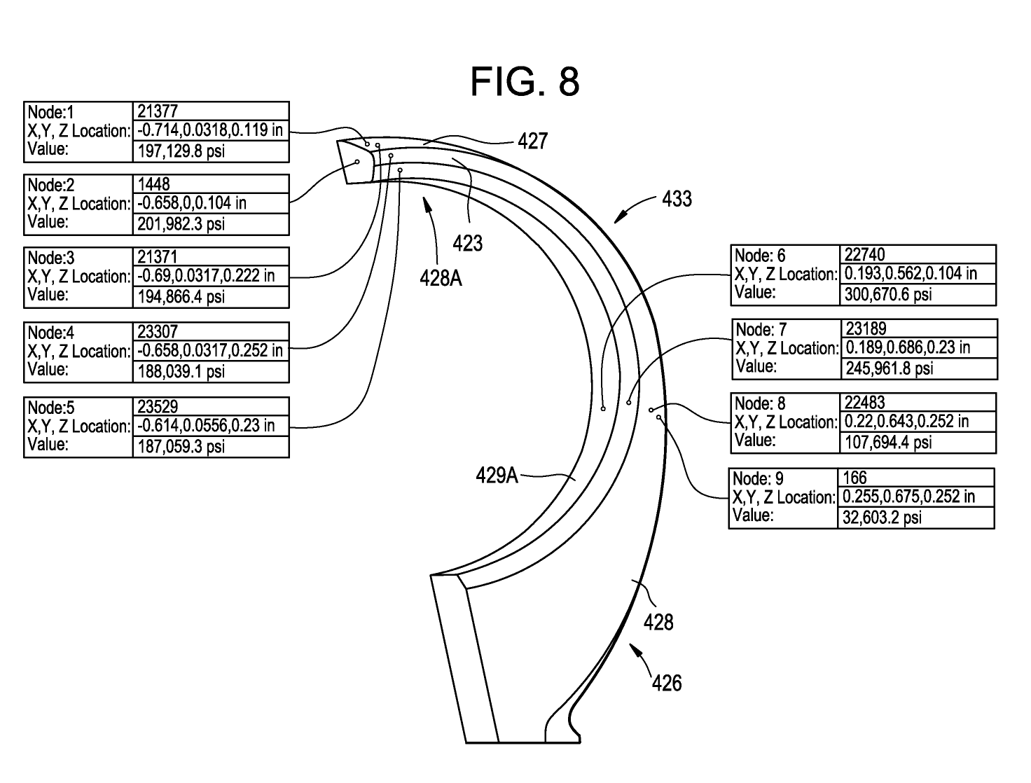

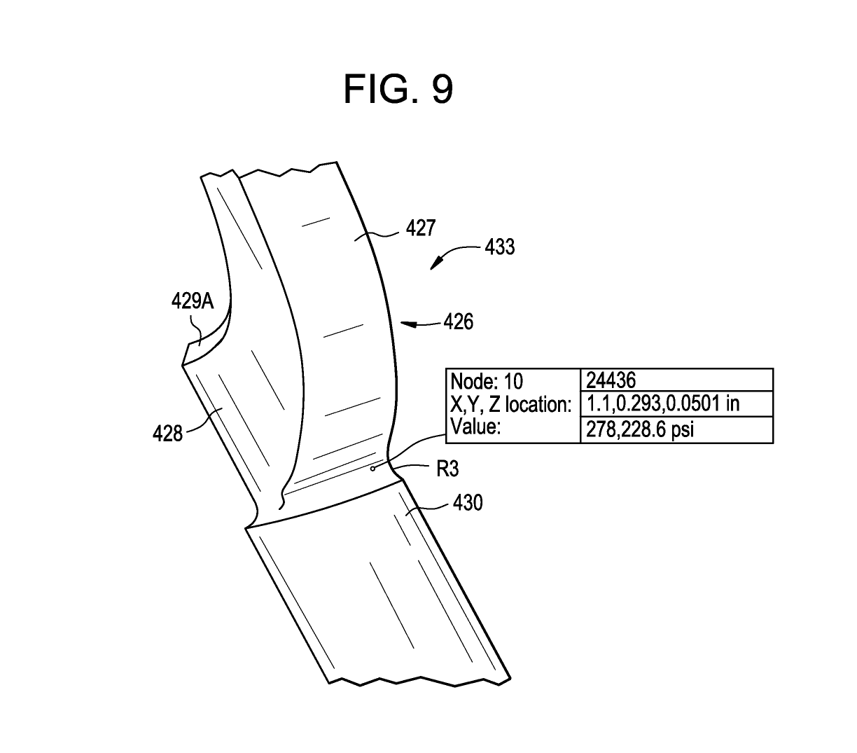

The linkage apparatus 433 having a particularly defined offset distance D3 provides a linkage apparatus that properly engages a short shanked clevis, eliminates the need for an additional fabrication process and provides an advantageous stress concentration profile enabling the linkage apparatus to carry higher loads as compared to prior art linkages, as further described herein with respect to FIGS. 8 and 9.

In one embodiment, the low profile linkage apparatus 433 has a bearing assembly 10 staked therein and the bearing assembly 10 includes a high-temperature self-lubricating liner system formulated with PFOA PTFE bonded with a polyimide resin system. The low profile linkage apparatus 433 is particularly useful in limited space applications having high dynamic loading and oscillation. In addition, the low profile linkage apparatus 433 having an offset distance D3 is particularly useful in resolving interference issues that arise when assembling the linkage apparatus with other components of an actuator assembly or system. For example, such an interference may arise when connecting the linkage apparatus to a fastener that provides for rotation along selected axes while restricting rotation in others, such as, for example, a clevis fastener with short shanks or short receiving members. In such an application, the low profile linkage apparatus 433 defines an offset distance D3 of sufficient distance to alleviate the interference by reducing the material envelope of the head portion 428 of the socket 426 of the low profile linkage apparatus 433.

As described above with reference to FIGS. 7A-C, one embodiment of the linkage apparatus 433 is configured to be operable with a VBV actuator assembly. The linkage apparatus 433 must support a static radial load in the range of up to about 20,000 lbs which corresponds to certain operating parameters and conditions associated with the engagement of the VBV actuator assembly. In one embodiment, the linkage apparatus 433 is fabricated from a martensitic precipitation/age-hardening stainless steel exhibiting high strength and hardness along with sufficient resistance to corrosion and stress-corrosion cracking. Such an alloy also exhibits sufficient ductility and toughness in both the longitudinal and transverse directions. One such material is known as 17-4 PH stainless steel. Another such material is known as PH 13-8, an alloy comprising 13% Chromium and 8% Nickel in accordance with the SAE International Standard AMS 5629. Such materials are hardened by heat treatment and are specified by a “Condition” according to such heat treatment. For example, Condition H 950, H 1000, H 1025, H 1050, H 1100, or H 1150 signifies the material is precipitation or age hardened by heating solution-treated material at a specified temperature. In one embodiment, the linkage apparatus 433 is fabricated from PH 13-8 Condition H 1000.

A finite element analysis (“FEA”) of three of the linkage apparatuses 433 was conducted by the inventors. One of the linkage apparatuses 433 was manufactured from 17-4PH Condition H1150, another from 17-4PH Condition H1025 and a third from PH 13-8 Condition H 1000. The finite element analysis was completed using SolidWorks® Simulation software. (SolidWorks® is a registered trademark of Dassault Systèmes SolidWorks Corporation.) The FEA was performed using a non-linear static analysis with a quarter model assembly with dual symmetry for simplicity. The results of the stress analysis are provided below in Table 1. Based on the stress analysis, the linkage apparatus 433 fabricated from PH 13-8 Condition H 1000 exhibits a yield strength exceeding 200 kilopounds per square inch (“ksi”) and thus supports the required load of 20,000 lbs without risk of plastic deformation.

TABLE 1

| | | Yield | Tensile | |
|---|---|---|---|---|
| | Heat Treat | Strength | Strength | Average Stress |
| Material | Condition | (ksi) | (ksi) | (ksi) |
| 17-4PH | H1150 | 125 | 100 | 166.879 |
| 17-4PH | H1025 | 155 | 145 | 167.058 |
| PH13-8 | H1000 | 201 | 190 | 166.636 |

The results of the stress analysis of the linkage apparatus 433 are illustrated in FIGS. 8 and 9 with respect to a plurality of nodes 1-10 designated on the linkage apparatus 433. Each of the nodes 1-10 is designated by a set of coordinates (x, y, z). As indicated in FIG. 8, peak stresses increase due to the reduction in material at certain designated nodes, such as, for example, nodes 6 and 7 that exhibit a stress value respectively of about 300 ksi and about 245 ksi, respectively. As further indicated in FIG. 8, node 2, located at a top portion 428A of the head portion 428 of the socket 426 of the low profile linkage apparatus 433 exhibits a stress value of about 202 ksi. As indicated in FIG. 9, a high stress area is located at the neck of the stem 430 at node 10 and exhibits a stress value of about 278 ksi. A root radius “R3” drives the stress concentration. In one embodiment of the linkage apparatus 433, R3 is increased to reduce the vulnerability to the exhibited stress in this area.

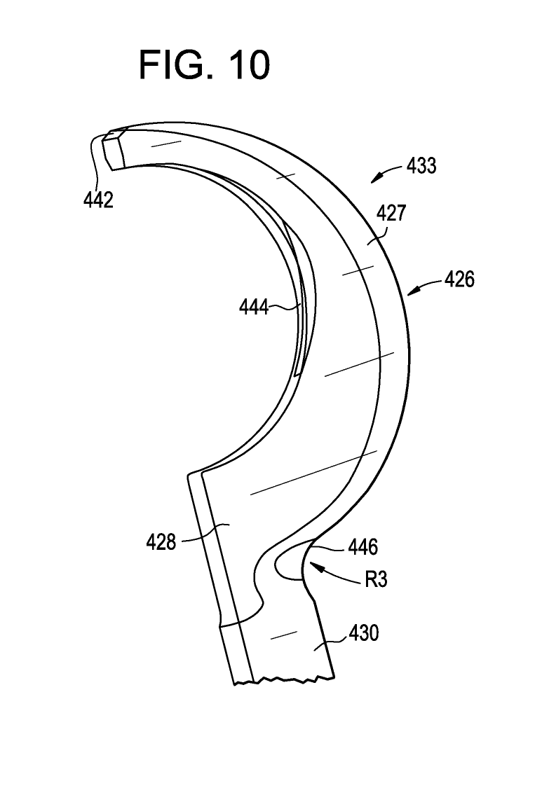

A plot of the stress area concentrations of the linkage apparatus 433 is shown in FIG. 10 and correlates with the stress values exhibited at nodes 1-10 in FIGS. 8 and 9. The stress area concentrations include: (i) a first location 442 that corresponds to node 1 and exhibits a stress value of about 197 ksi; (ii) a second location 444 that corresponds to node 6 and exhibits a stress value of about 300 ksi; and (iii) a third location 446 that corresponds to node 10 and exhibits a stress value of about 278 ksi.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A linkage apparatus for actuation of a positioning device, the linkage apparatus comprising:
a pivot member having a head portion configured to receive by plastic deformation a bearing assembly therein, the head portion defining a bore therein having a substantially cylindrical inner surface that defines an inner diameter having a first center point, the head portion further defining a truncated arcuate outer surface, a portion of which defines a radius of curvature and a second center point;
a stem having a central axis, the stem extending from the pivot member along the central axis in a first direction; and
the second center point is offset from the first center point in the first direction and a distance between the first center point and the second center point, measured along the central axis, is up to about 33% of the radius of curvature.

2. The linkage apparatus of claim 1 wherein the distance between the first center point and the second center point is from about 5% to about 25% of the radius of curvature.

3. The linkage apparatus of claim 1 wherein the linkage apparatus is fabricated from a martensitic precipitation/age-hardening stainless steel alloy.

4. The linkage apparatus of claim 1 wherein the linkage apparatus is fabricated from PH 13-8.

5. The linkage apparatus of claim 1 wherein the linkage apparatus is configured to be operable with a turbofan engine fan bleed air system.

6. The linkage apparatus of claim 5 wherein the linkage apparatus is configured to be operable with a variable bypass vane actuator assembly.

7. The linkage apparatus of claim 1 further comprising the head portion plastically deformed around a bearing assembly.

8. The linkage apparatus of claim 7 wherein the bearing assembly comprises:
an inner member having an outer engagement surface and a bore extending at least partway therethrough;
an outer member positioned at least partially around the inner member, the outer member having an inner engagement surface contoured to a shape complementary to the outer engagement surface of the inner member; and
a self-lubricating liner disposed between the inner engagement surface of the outer member and the outer engagement surface of the inner member.

9. The linkage apparatus of claim 8 wherein the liner of the bearing assembly comprises a polytetrafluoroethylene (“PTFE”) bonded with a thermoset resin.

10. The linkage apparatus of claim 8 wherein the liner of the bearing assembly comprises a perfluorooctanoic acid (“PFOA”) polytetrafluoroethylene (“PTFE”) bonded with a polyimide resin system.

11. The linkage apparatus of claim 8 wherein the liner of the bearing assembly comprises a Teflon® liner containing no PFOA.

12. The linkage apparatus of claim 8 wherein the liner of the bearing assembly comprises a Teflon® liner containing PFOA.

13. A linkage apparatus for actuation of a positioning device, the linkage apparatus comprising:
a positioning member defining a first end, a second end, and a central axis therethrough;
a pivot member defined at the first end of the positioning member and having a head portion configured to receive by plastic deformation a bearing assembly therein, the head portion defining a bore therein having a substantially cylindrical inner surface that defines an inner diameter having a first center point, the head portion further defining a truncated arcuate outer surface, a portion of which defines a radius of curvature and a second center point;
a stem extending from the pivot member along the central axis of the positioning member in a first direction;
a coupling member defined at the second end of the positioning member for coupling the positioning member to a structural member; and
the second center point is offset from the first center point in the first direction and a distance between the first center point and the second center point, measured along the central axis, is in the range of up to about 33% of the radius of curvature.

14. The linkage apparatus of claim 13 wherein the linkage apparatus is fabricated from PH 13-8.

15. The linkage apparatus of claim 13 further comprising the head portion plastically deformed around a bearing assembly.

16. The linkage apparatus of claim 13 wherein the bearing assembly comprises:
an inner member having an outer engagement surface and a bore extending at least partway therethrough;
an outer member positioned at least partially around the inner member, the outer member having an inner engagement surface contoured to a shape complementary to the outer engagement surface of the inner member; and
a self-lubricating liner disposed between the inner engagement surface of the outer member and the outer engagement surface of the inner member.

17. The linkage apparatus of claim 16 wherein the liner of the bearing assembly comprises a polytetrafluoroethylene (“PTFE”) bonded with a thermoset resin.

18. The linkage apparatus of claim 16 wherein the liner of the bearing assembly comprises a perfluorooctanoic acid (“PFOA”) polytetrafluoroethylene (“PTFE”) bonded with a polyimide resin system.

19. The linkage apparatus of claim 16 wherein the liner of the bearing assembly comprises a Teflon® liner containing no PFOA.

20. The linkage apparatus of claim 16 wherein the liner of the bearing assembly comprises a Teflon® liner containing PFOA.

21. A bearing assembly for use in a linkage apparatus, the bearing assembly comprising:
an inner member having an outer engagement surface and a bore extending at least partway therethrough;
an outer member positioned at least partially around the inner member, the outer member having an inner engagement surface contoured to a shape complementary to the outer engagement surface of the inner member; and
a self-lubricating liner disposed between the inner engagement surface of the outer member and the outer engagement surface of the inner member, the liner containing no PFOA.

22. The linkage apparatus of claim 7 wherein the bearing assembly comprises:
an inner member having an outer engagement surface and a bore extending at least partway therethrough;
an outer member positioned at least partially around the inner member, the outer member having an inner engagement surface contoured to a shape complementary to the outer engagement surface of the inner member; and
a self-lubricating liner disposed between an inner surface of the bore of the inner member and a shaft extending at least partway therethrough.

23. The linkage apparatus of claim 8 wherein the bearing assembly comprises:
an inner member having an outer engagement surface and a bore extending at least partway therethrough;
an outer member positioned at least partially around the inner member, the outer member having an inner engagement surface contoured to a shape complementary to the outer engagement surface of the inner member; and
a self-lubricating liner disposed between an inner surface of the bore of the inner member and a shaft extending at least partway therethrough.
